(19) United States
(12) Patent Application Publication
(10) Pub. No.: US 2007/0290530 A1
(43) Pub. Date: Dec. 20, 2007

(54) Seat Recliner Bench for Motor Homes or the Like

(76) Inventor: Reinhold Brueckner, Herzebrock-Clarholz (DE)

Correspondence Address: CROWELL & MORING LLP;INTELLECTUAL PROPERTY GROUP, P.O. BOX 14300, WASHINGTON, DC, 20044-4300, US

(21) Appl. No.: 11/596,122

(22) PCT Filed: May 12, 2005
(86) PCT No.: PCT/EP05/05169

§ 371 Date: Jun. 26, 2007

(30) Foreign Application Priority Data
May 12, 2004 (DE) 10 2004 023 404.3

(51) Int. Cl. B60N 2/34

(52) U.S. Cl. 297/118

(57) ABSTRACT

A reclining bench seat for a recreational vehicle has a frame on which a seat part and a backrest part are arranged. The backrest part can be pivoted between a sitting position and a lying position. In the lying position, the rear of the backrest part is arranged so as to be located at the top. In order to be able to perform the pivoting between the sitting position and the lying position easily and without changing the design of the seat part, the frame, including the seat part and the backrest part, is mounted such that it can be pivoted in its entirety.

The invention relates to a reclining bench seat according to the precharacterizing clause of Patent Claim 1.

In the case of the generally known reclining bench seats for recreational vehicles, as a rule both the seating area and the backrest area are used in the lying position as a lying area for sleeping. To this end, the seating area and backrest area are moved into the most horizontal alignment possible, for which purpose specific fittings are used in order to be able to lower the backrest rearwards by an appropriate distance and to be able to raise the seating area in its rear region.

A reclining bench seat of the type mentioned at the beginning is known in which not only the rear of the backrest part but also the underside of the seat part can be used located at the top in order to form the lying area. This has the advantage of being able to use the uncontoured rear of the backrest part to form a flat lying area. However, in this known design, complicated mechanisms are necessary in order to be able to convert the seat part and the backrest part of the reclining bench seat from the sitting position to the lying position.

The invention is based on the object of providing a reclining bench seat in which not only can the rear of the backrest part be pivoted so as to be located at the top in order to form the lying area, but the pivoting can be carried out very simply without having to carry out conversions on the seat part.

In the case of a reclining bench seat of the type mentioned at the beginning, this object is achieved by the characterizing features of Patent Claim 1.

For the invention, it is important to be able to pivot the reclining bench seat in such a way that the relative position of the seat part and the backrest part in relation to each other is maintained, since the seat part and the backrest part are tilted jointly about a single axis of rotation, the seat part having no function in the lying position. The conversion from the sitting position to the lying position is carried out in that, following appropriate unsecuring, the entire bench is tipped forwards until the flat rear of the backrest part is aligned located at the top and the bedding can be placed thereon. Advantageously, the associated mattress is simultaneously fixedly arranged on the rear of the backrest part and, during the conversion from the sitting position to the lying position and vice versa, accordingly pivots with it.

Further advantageous refining features of the invention emerge from the subclaims.

The invention will be explained in more detail below on an exemplary embodiment and by using the drawing, in which:

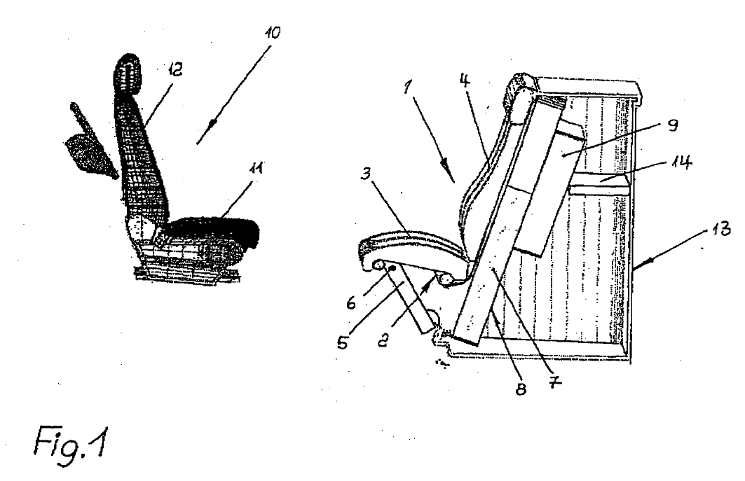

FIG. 1 shows, in a schematic illustration, the side view of a reclining bench seat in the sitting position, including a front seat arranged opposite it,

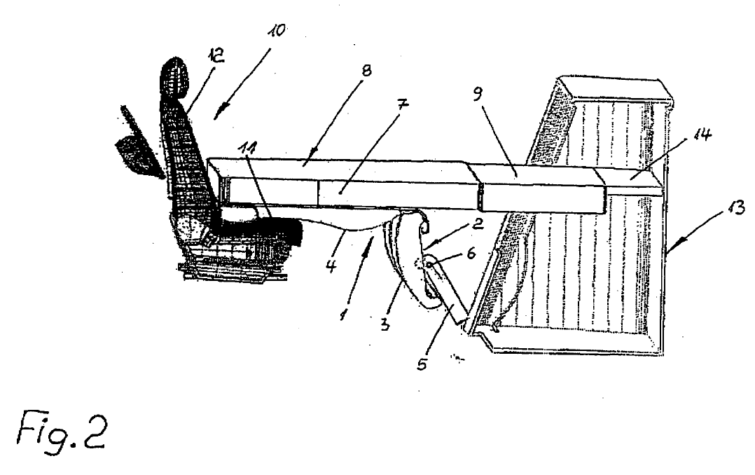

FIG. 2 shows an illustration corresponding to FIG. 1 but in the lying position of the reclining bench seat,

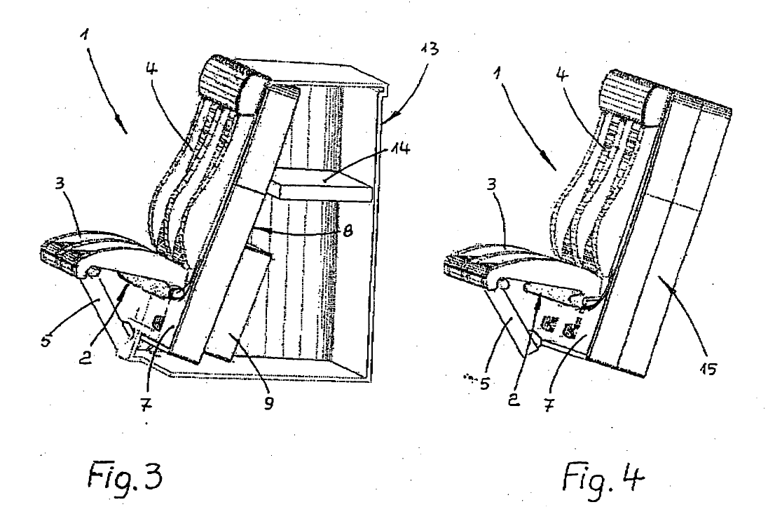

FIG. 3 shows a perspective side view of the reclining bench seat in a slightly modified design,

FIG. 4 shows a further variant of the reclining bench seat,

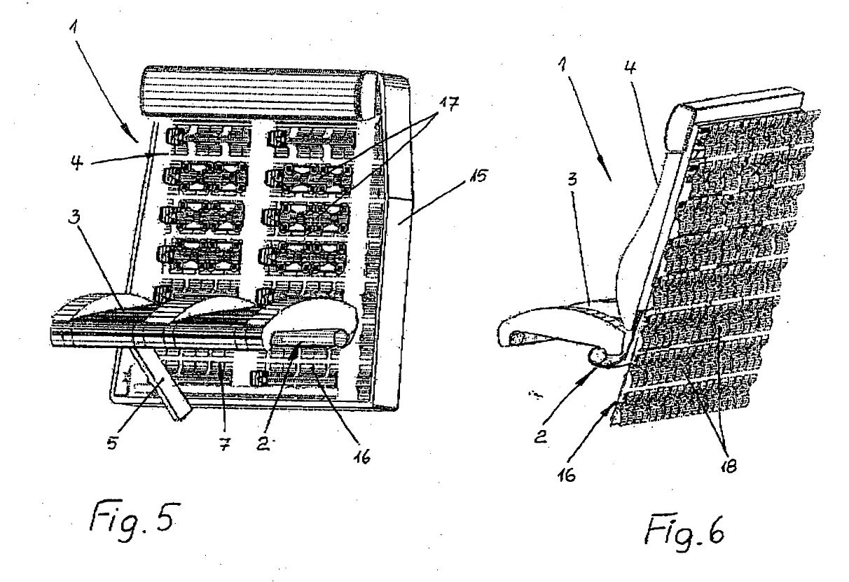

FIG. 5 shows a perspective front view of the reclining bench seat in a partly opened-up illustration of the backrest part,

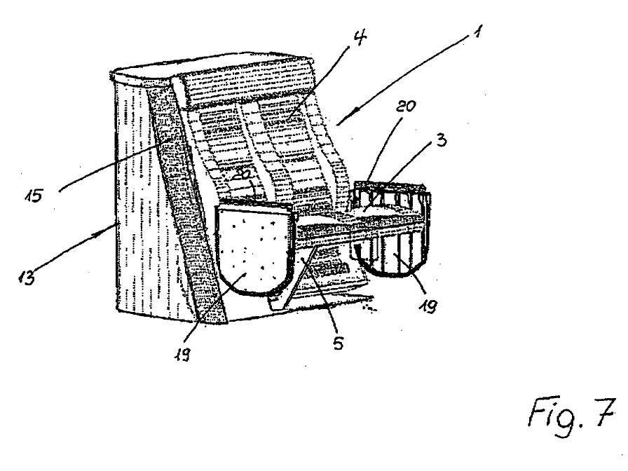

FIG. 6 shows a perspective rear view of the reclining bench seat with an opened-up reproduction of the backrest part, and

FIG. 7 shows a perspective front view of the reclining bench seat in a further embodiment.

FIG. 1 reveals in detail a reclining bench seat 1 having a frame 2, not specifically illustrated in detail, on which a seat part 3 and a backrest part 4 are arranged together. The frame 2 is mounted on a supporting device 5, which is arranged in a stationary manner in the relevant vehicle, such that it can be pivoted between a sitting position, which emerges from FIG. 1, and a lying position, which is illustrated in FIG. 2. For this purpose, at the upper end of the supporting device 5 there is located a single pivot axis 6, about which the seat part 3 and the backrest part 4 can be tilted together. This is done from the sitting position, in which the seat part 3 and the backrest part 4 are tilted forwards, after which the rear of the backrest part 4 is aligned horizontally in the lying position, which is reproduced in FIG. 2. In the lying position, the seat part 3 has no function; instead, it is pivoted downwards into a free space which, because of the necessary floor spacing of the upper side of the backrest part 4 in the lying position, is available in any case to accommodate the seat part 3 in the lying position.

Fixedly arranged on the rear of the backrest part 4 is at least one mattress 7 which, in the sitting position, terminates at the top with the backrest part 4 but reaches downwards further than the backrest part 4 as far as the vehicle floor. With its side facing away from the backrest part 4, the mattress 7 forms a lying area 8, which can be enlarged by means of an additional mattress part 9.

In the installed position in the relevant vehicle, front seats 10 are arranged in front of the reclining bench seat 1 in the vehicle longitudinal direction and can be rotated about a vertical axis in order to be able to pivot them from the normal alignment into a position rotated counter to the direction of travel. The arrangement counter to the direction of travel is illustrated for one of the front seats 10 in FIGS. 1 and 2. The seat 10 has a seat part 11 and a backrest part 12 in the usual way. The combination of the tiltable reclining bench seat 1 with the rotatable front seat 10 results in a space-saving arrangement in the lying position of the reclining bench seat 1, which can be seen in FIG. 2. In the lying position, the leaning part 4 of the reclining bench Beat 1 reaches over the seat part 11 of the front seat 10 as far as the backrest part 12 of the latter. In this case, the backrest part 4 of the reclining bench seat 1 can be supported on the seat part 11 of the front seat 10, for which purpose the leaning contour of the backrest part 4 of the reclining bench seat 1 and the sitting contour of the seat part 11 of the front seat 10 can be matched to each other.

A further space-saving arrangement results with the reclining bench seat 1 by means of a fitted cupboard 13 located behind it in the relevant vehicle. The fitted cupboard 13 has an opening located at the front which, in the sitting position of the reclining bench seat 1, is closed by its backrest part 4 and the mattress 7 located thereon. On the backrest part there can be lateral shields 15, as FIGS. 4 and 5 illustrate, which can firstly cover the mattress 7 located on the backrest part 4 at the side and secondly can be constructed in such a way that they adjoin the opening of the fitted cupboard 13, in order to achieve a harmonious design in the sitting position of reclining bench seat 1 and fitted cupboard 13. In the fitted cupboard 13 there is a bracket 14, on which the additional mattress part 9, if it is arranged loosely, can be mounted. The mattress part 9 can be accommodated in the fitted cupboard 13, as can the bedding which is also necessary.

In another embodiment, the additional mattress part 9 can be arranged on the mattress 7 by being arranged thereon by means of a hook and loop device such that it can be removed, or being fastened thereto by means of at least one hinge such that it can be pivoted or folded. Different arrangements and constructions of the additional mattress part 9 are shown by FIGS. 1-3. It is generally critical to be able to increase the length of the lying area 8 of the mattress 7 fixed to the backrest part 4 by using the mattress part 9. For example, the additional mattress part 9 can be attached to the bracket 14 in the fitted cupboard 13 such that it can be pivoted; in another embodiment, it can be folded from the mattress 7 onto the bracket 14 in the lying position of the reclining bench seat 1.

The inner structure of the backrest part 4 and the mattress 7 fixed thereto can be gathered from FIGS. 5 and 6. Both have a common springing element 16 in the form of a lattice frame which, in the region of the backrest part 4, is equipped at the front with spring elements 17 which are used to increase the sitting and leaning comfort of the backrest part 4, which is important for the use of the reclining bench seat 1 in the sitting position. In the region underneath the lying area 8, that is to say on the side of the mattress 7 facing away from the backrest part 4, there are spring elements 18 on the lattice frame of the springing system 16, which are matched to the lying comfort which is important for the use of the reclining bench seat in the lying position.

FIG. 7 shows a further special feature of the reclining bench seat 1. Arranged on the seat part 3 are folding tables 19, on which armrests 20 are formed on the edges located at the top in the folded-down position. Since, during pivoting from the sitting position into the lying position and vice versa, the seat part 3 and the backrest part 4 are moved as one, in this case the folding tables 19 fixed to the seat part 3, including the armrests 20, also pivot with them.

1-16. (canceled)

17. A reclining bench seat for motorhomes, caravans, vans or the like, comprising:
a frame,
a seat part arranged on the frame, and
a backrest part arranged on the frame,
wherein in a lying position, a rear of the backrest part is arranged so as to be located at the top, and
wherein the frame, the seat part, and the backrest part are mounted such that the frame can be pivoted between a sitting position and the lying position.

18. The reclining bench seat according to claim 17, wherein a mattress is fixedly arranged on the rear of the backrest part and, with its side facing away from the rear of the backrest part, forms a lying area.

19. The reclining bench seat according to claim 18, wherein a mattress part is provided in addition to the mattress so as to enlarge the lying area.

20. The reclining bench seat according to claim 19, wherein the mattress part is detachably fastened to the mattress fixedly arranged on the rear of the backrest part.

21. The reclining bench seat according to claim 19, wherein the mattress part is detachable from the mattress or is loose relative thereto and can be mounted on a part of vehicle furnishings of the relevant vehicle and, in a mounted position, closely adjoins the mattress arranged on the rear of the backrest part in a tilted, lying position of the seat part and the backrest part.

22. The reclining bench seat according to claim 19, wherein in a non-use position, the mattress part is arranged to rest on the side of the mattress forming the lying area.

23. The reclining bench seat according to claim 22, wherein the mattress part is attached to the backrest part or to the mattress arranged fixedly thereon such that it can pivot.

24. The reclining bench seat according to claim 19, wherein a sitting width of the seat part and the backrest part and the lying width of the mattress are different.

25. The reclining bench seat according to claim 24, wherein a width of the mattress part is different from the sitting and lying widths.

26. The reclining bench seat according to claim 18, wherein the mattress, in the upright, sitting position of the backrest part, dips fully or partly into a fitted vehicle cupboard forming the part of vehicle furnishings.

27. The reclining bench seat according to claim 26, wherein, on the frame, there is arranged a shield covering the mattress at a side.

28. The reclining bench seat according to claim 27, wherein the shield covering the mattress at the side adjoins the opening of the part of the vehicle furnishings, forming the fitted vehicle cupboard, so as to be flush.

29. The reclining bench seat according to claim 18, wherein the backrest part and the mattress have a common springing system located between the mattress and the backrest part.

30. The reclining bench seat according to claim 29, wherein the springing system comprises a lattice frame.

31. The reclining bench seat according to claim 30, wherein the springing system has first spring elements towards a leaning side and second spring elements towards a mattress side, and wherein the spring elements are formed differently in accordance with sitting comfort and lying comfort.

32. The reclining bench seat according to claim 17, further comprising attachments arranged on the seat part, wherein, during pivoting between the sitting position and the lying position, the attachments pivot.

33. The reclining bench seat according to claim 32, wherein the attachments include at least one of armrests and folding tables.

34. The reclining bench seat according to claim 17, in combination with front seats which can be rotated counter to the forward direction of travel, wherein, in a position of the front seats rotated counter to the forward direction of travel and, in a lying position of the reclining bench seat, the backrest part of the latter tilted over forwards reaches over the seat part of the front seats as far as the backrest part of the latter.
